(19) United States
(12) Patent Application Publication
(10) Pub. No.: US 2009/0316530 A1
(43) Pub. Date: Dec. 24, 2009

(54) BI-DIRECTIONAL SEISMIC COMMUNICATION SYSTEM AND METHOD

(76) Inventors: Jerry Bunyard, Madison, AL (US); Jerry Cross, Huntsville, AL (US); Ric Rice, Huntsville, AL (US); Peter Shinkunas, Madison, AL (US)

Correspondence Address: MCGUIREWOODS, LLP, 1750 TYSONS BLVD, SUITE 1800, MCLEAN, VA, 22102, US

(21) Appl. No.: 12/484,616

(22) Filed: Jun. 15, 2009

Related U.S. Application Data
(60) Provisional application No. 61/073,725, filed on Jun. 18, 2008.

(51) Int. Cl. H04B 1/02; E21C 41/00

(52) U.S. Cl. 367/137; 299/10

(57) ABSTRACT

A system and method for communications in a mine provides for seismic wave generation through mine strata which may include specific location identification within the mine can be used in emergency situations by trapped miners. A seismic transmitting transducer may impart seismic waves onto a rod embedded into the strata, which is tunable by use of a slideable manifold that couple the transducer to a rod. Likewise, a receiving transducer which may also be coupled to a rod via a manifold may be configured to receive the seismic wave. The seismic wave may be modulated to produce a message or portion of a message that may be decoded at the receiving location. The transducers may be configured to utilize frequency hopping spread spectrum techniques. A geophone may be used as the receiving transducer.

### CROSS-REFERENCE TO RELATED APPLICATIONS

This application claims priority and benefit of U.S. Provisional Application No. 61/073,725 filed Jun. 18, 2008, entitled BI-DIRECTIONAL SEISMIC COMMUNICATION, which is incorporated by reference herein in its entirety.

### FIELD OF THE INVENTION

The present invention relates generally to seismic communications, and more particularly, to methods and apparatus to support communications between miners or other individuals trapped underground and their potential rescuers.

### BACKGROUND OF THE INVENTION

There is currently no reliable means by which rescue teams can locate or communicate with trapped miners during an emergency/catastrophic mining accident, such as an explosion or cave-in.

Mining accidents, such as the Sago, W.V. incident that occurred on Jan. 2, 2006, have revealed the immediate need for upgraded miner tracking and communications systems. The ability to communicate with the trapped miners in this event would have prevented the tragic loss of human life.

The advent of additional economically feasible uses for coal (such as quad separation which allows for oil extraction from coal), coupled with normal increasing demand will certainly result in an increase in coal production in the near future.

The Federal Government has passed legislation that levies mandatory requirements pertaining to automated tagging of miners. The Mining Act of 2006 requires that precision location and communication equipment be utilized by all U.S. underground mines. Such legislative actions are the result of the desire for employment of products that enhance miner safety during emergency operations. The legislation assumes that robust tracking and communications solutions are available and are required to be implemented immediately.

Tracking systems are becoming available that will operate reliably during normal operational modes. However, during emergency rescue operations all active power feeds to the mine are disabled to prevent the risk of explosions. A tracking system that would continue to operate during emergencies would have to rely upon its own Intrinsically Safe (IS) power source, and likewise could not rely upon an underground antenna system or wired system that might be damaged in the event of a fire, explosion or cave-in.

The following description of the present invention might be better understood after reviewing the following US patents, each of which is hereby incorporated herein by reference it its entirety: U.S. Pat. No. 3,273,112 issued to Hobson on Sep. 13, 1966 titled “Tuned Seismic Wave Communications System”; U.S. Pat. No. 3,302,746 issued to Ikrath on Feb. 7, 1967 titled “Self-Excited Seismic Systems”; U.S. Pat. No. 3,949,353 issued to Waters et al. on Apr. 6, 1976 titled “Underground Mine Surveillance System”; U.S. Pat. No. 6,885,918 issued to Harmon et al. on Apr. 26, 2005 titled “Seismic Monitoring and Control Method”; U.S. Pat. No. 6,037,682 issued to Shoop et al. on Mar. 14, 2000 titled “Integrated Multi-Mode Transducer and Method”. However, the present invention is both novel and non-obvious in light of the preceding patents, whether they are taken individually or in combination.

Current technology for seismic communication many times uses apriori strata empirical result in typical triangulation location algorithms. Typical flaws with this approach are ever-changing propagation results due to additional mining operations taking place over time for example only. The triangulation scheme also requires substantial communication nodes at higher costs and long set-up times.

The present invention should not be confused with an “elastic wave generator” or any other single impact device which is not capable of repetitive output. Furthermore, the present invention should not be confused with the Australian low frequency electromagnetic-based “PEDS” system.

### SUMMARY OF THE INVENTION

The invention is directed to methods and apparatus for seismic communications, more particularly, for transmitting, receiving, and interpreting communication signals comprising seismic modulations.

In some instances, such methods and apparatus utilize one or more of the following: multipath resistant seismic signature algorithms; low-frequency spread spectrum techniques; and/or acoustic frequency hopping using discrete impact modulation and/or analog tonals.

It is contemplated that the methods and apparatus described herein may be particularly beneficial in determining the location of, and communicating with, trapped miners. More particularly, if provided with the methods and apparatus described herein, trapped miners will have the ability to bi-directionally communicate their precise locations, receive instructions from rescue personnel, provide personnel health and welfare status, etc., through the strata.

It has been found to be possible to bi-directionally transmit low power sinusoid based text messages through limestone strata at a distance of over 200 feet. In addition, it has been found that signals generated using sledge hammer blows were detectable at ranges of over 1500 feet through the limestone with excellent Signal to Noise Ratio (SNR).

The methods and apparatus described herein might use components that may include variants of existing undersea naval communications products. Such products can be modified, hardware/firmware tuned and tested for use in operational mines.

Preferred embodiments may generally not rely exclusively on, and in some instances may not even use, time arrival of incident signal reception, or triangulation of single point transmission correlated by multiple detection points.

In one aspect, a system for communication in mines is provided that includes a transmitting transducer coupled to a first rod at a first location and a receiving transducer coupled to a second rod at a second location, wherein the transmitting transducer is configured to produce seismic waves through mine strata from the first location to the second location, the first rod embedded in the mine strata at the first location, and wherein the seismic waves are modulated to convey a message to the receiving transducer at the rod embedded in the mine strata at the second location.

In another aspect, a method of communication includes providing at least one transmitting transducer configured to transmit seismic waves representing at least a portion of a message and providing at least one receiving transducer configured to receive the seismic wave and at least a portion of a message, wherein the transmitting and receiving transducers are each coupled to a rod implanted in strata.

In another aspect, a method of mining is provided that includes providing at least one transmitting transducer configured to transmit seismic waves representing at least a portion of a message, providing at least one receiving transducer configured to receive the seismic wave and the at least a portion of a message and obtaining mineral deposits from the mine, wherein the transmitting and receiving transducers are each coupled to a rod implanted in strata.

### BRIEF DESCRIPTION OF THE DRAWINGS

The exact nature of this invention, as well as the objects and advantages thereof, will become readily apparent from consideration of the following detailed description in conjunction with the accompanying drawings in which like reference numerals designate like parts throughout the figures thereof and wherein:

FIG. 1 is an illustration showing an exemplary mine layout including a logical block diagram of a communication system configured according to principles of the invention;

FIG. 2 illustrates communication using an aspect of the invention between miners located at a safe refuge chamber within a mine, which might include direct and/or indirect communication to the surface, according to principles of the invention;

FIG. 3A is an exemplary block diagram of an aspect of an adjustable mounting block portion of a manifold assembly, configured for transmission according to principles of the invention;

FIG. 3B is an exemplary block diagram of another embodiment of an adjustable mounting block portion of a manifold assembly, configured for reception according to principles of the invention;

FIGS. 3C-3D are sectional views of portions of the adjustable mounting block portion of the manifold of FIGS. 3A and 3B;

FIG. 4 is a graph of actual test results employing a 20 lb. sledge, generated according to principles of the invention;

FIG. 5 is a graph of the entire 10 second spectrum of FIG. 4, according to principles of the invention;

FIG. 6 is a time dependent spectral plot of the data employed in FIG. 4;

FIG. 7 is a spectral plot of a band pass digital filter;

FIG. 8 is a graph of the output from the digital filter on the data of FIG. 4;

FIG. 9 is a graph of dataset 902 with digital filtering; and

FIG. 10 is a graph of four sets of sledge hammer data plotted to determine the loss of signal as a function of range, according to principles of the invention.

### DETAILED DESCRIPTION OF THE INVENTION

It is understood that the invention is not limited to the particular methodology, protocols, etc., described herein, as these may vary as the skilled artisan may recognize. It is also to be understood that the terminology used herein is used for the purpose of describing particular embodiments only, and is not intended to limit the scope of the invention. It is also to be noted that as used herein and in the appended claims, the singular forms “a,” “an,” and “the” include the plural reference unless the context clearly dictates otherwise. Thus, for example, a reference to “an address” is a reference to one or more addresses and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law.

The invention utilizes the transmission and detection of underground seismic signals for communication. The methods and/or apparatus performed or configured according to principles of the invention support bidirectional communication such as between trapped miners and their potential rescuers.

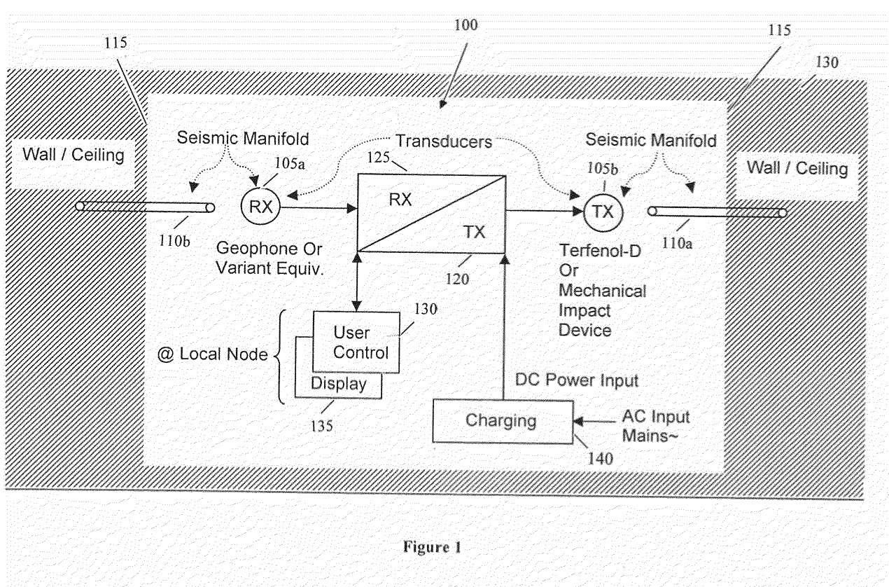

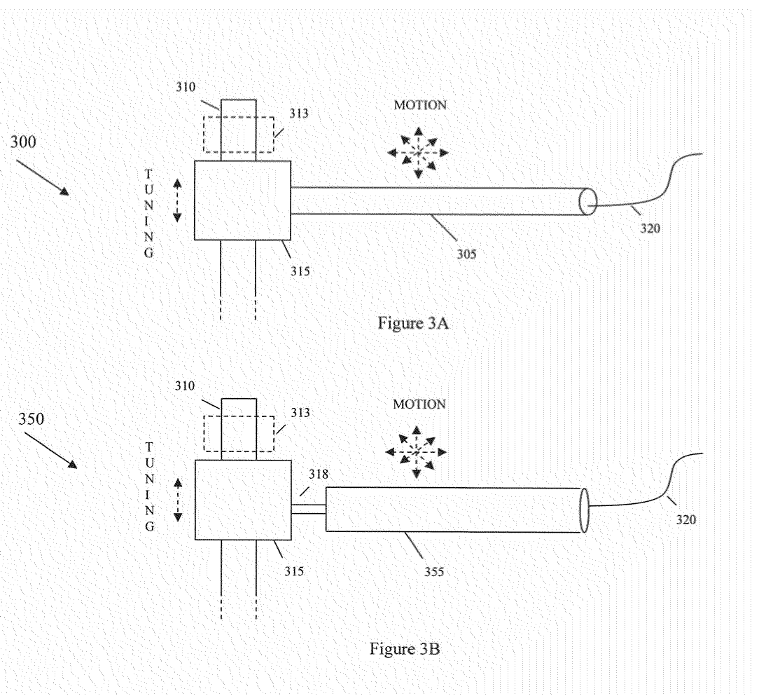

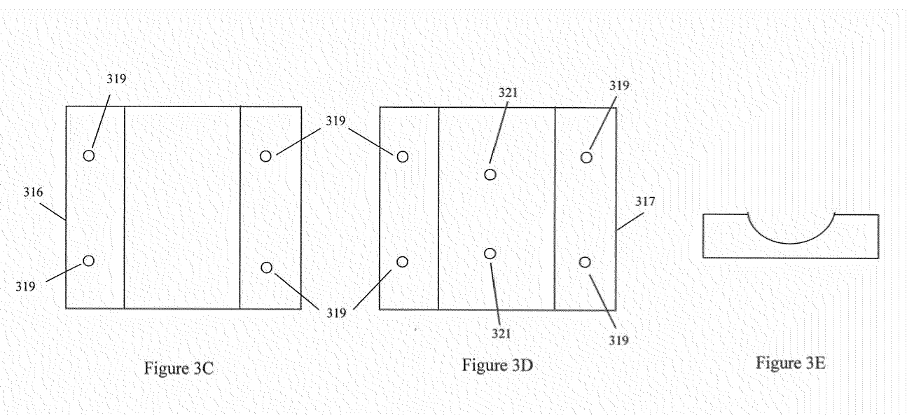

FIG. 1 is an illustration showing an exemplary mine layout including a logical block diagram of a communication system configured according to principles of the invention including transducers deployed at optimized intervals throughout a mine, the system generally denoted by reference numeral 100. The system 100 relies upon intrinsically safe intelligent-reliable seismic signals being communicated via a plurality of seismic transducers 105a, 105b that are coupled to the strata 130. As shown in FIG. 1, the seismic manifolds may include transducers 105a-105b, the rods 110a-110b (e.g., hollow and/or solid steel rods) that may be embedded in the drift wall 115, the adhesive or cement that tightly couples the rod to the strata 130, the adjustable transducer mounting block 315 as shown in FIGS. 3A and 3B, and the coupling mechanism between the mounting blocks and the transmitter 120 and/or receiver 125 transducers. Additional fixed and/or movable masses may be attached as a part of the manifold to enhance system performance. The system 100 may further include a transmitter 120, receiver 125 and a user control module 130 for pre-setting message contents, communication formats and/or operational parameters, which may be interfaced to a user display 135. The system 100 may be powered by a power source 140. Of course fewer or more components may be included in system 100.

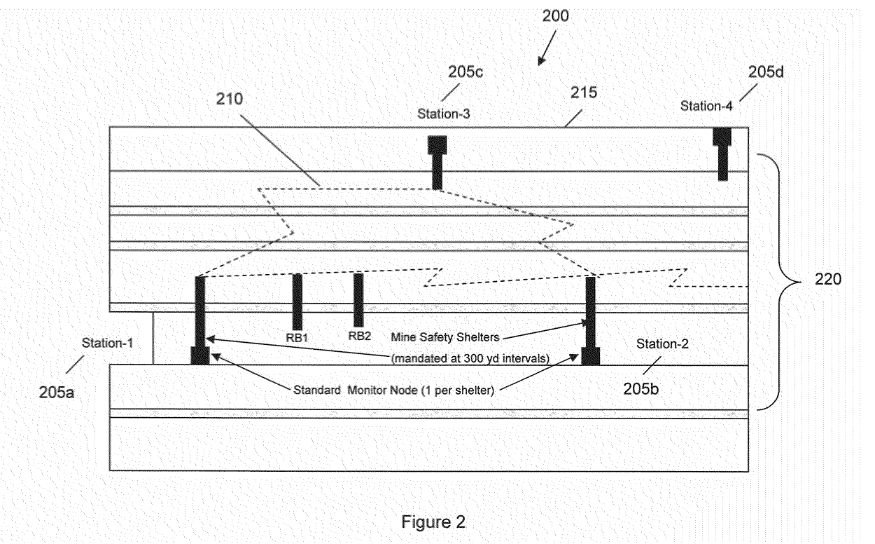

FIG. 2 illustrates communication using an embodiment of the invention between miners located at a safe refuge chamber within a mine, which might include direct and/or indirect communication to the surface, according to principles of the invention, generally denoted by reference numeral 200. The components of FIG. 1 may be installed at or between one or more mine safety shelters labeled in this example as station-1 (205a), station-2 (205b), station-3 (205c) and station-4 (205d). Direct reception of signals 210 at or near the surface 215, such as at station-3 (205c) and/or at station-4 (205d), may involve an implementation that may require signal detection through multiple non-contiguous layers of strata 220 over varying depths. This vertical transmission range may vary from mine to mine, usually in excess of 1000 feet (FIG. 2—station-1 to station-3). FIG. 2 also shows roof bolts RB1 and RB2, as is known in the art. The current governmental mandated spacing of the mine safety shelters is shown at 300 yards. Of course other spacings and ranges are contemplated.

Indirect reception, reference FIG. 2 (station-1 to station-2 to station-3, for example), may involve at least one relay “hop” of the incident seismic transmission horizontally and/or vertically. Adjacent nodes, perhaps strategically located on about 900 foot centers (to coincide with shelter locales defined in the Mining Act of 2006), may be configured to behave as simplex transceivers. They may be configured to pass higher SNR signals until vertical path loss could be overcome with sufficient SNR to be received at the surface 215. This may provide reception of signals to be received at a station, e.g., station-3, at the uppermost surface of the strata. An alternate approach to getting to the surface is via an RF gateway as discussed more fully below. Reception of signals may be received at a station, e.g., station-3, at the uppermost surface of the strata.

FIG. 3A is an exemplary block diagram of an embodiment of an adjustable mounting block portion of a manifold assembly, configured for transmission according to principles of the invention generally denoted by reference numeral 300. The manifold assembly 300 may include an impact device 305, such as an impact hammer or a Terfenol-D unit (Terfenol-D is a magnetostrictive material, a material that changes shape when placed in a magnetic field), removably attached to adjustable mounting block 315. The adjustable mounting block 315 may be removably and slideably attached to a rod 310, which may be implantable in strata 220 or 130. The rod may be cemented or implanted using an adhesive. The adjustable mounting block 315 and impact device 305 combination may be attached to rod 110a of FIG. 1, for example. Impact device 305, may be configured to produce seismic waves at pre-determined frequencies and/or power to move rod 310 (or rod 110a) at a predetermined frequency in strata to produce seismic waves. The adjustable mounting block 315 may be moved along the rod 310 to better tune the manifold assembly. Additional fixed and/or movable masses may be attached as a part of the manifold to further tune the manifold assembly. Electrical connectivity 320 is also shown for conveying electrical signals.

The rod 310 may be cemented or implanted using an adhesive. The embedding of the rods to the strata should be solid and tight. The rods may be made from many different types of rigid materials. Steel rods have performed well. The rods may be 1½ inch diameter cylinder shaped rods that measure about 7 feet in length. The rods may be embedded about four feet in strata, with about three feet protruding from the strata. However, other dimensions of rods and depths may be employed. The rods may be solid or hollow. Selection of rod types, rod geometric dimensions, orientation of the rods, and depth of embedding may be dependent on the type of strata encountered. Moreover, the transmission types employed may also depend on the strata types.

FIG. 3B is an exemplary block diagram of another aspect of an adjustable mounting block portion of a manifold assembly, configured for reception according to principles of the invention generally denoted by reference numeral 350. This aspect 350 is similar to FIG. 3A, except a ground motion transducer 355 (e.g., a geophone, a highly sensitive ground motion transducer that has been used by seismologists and geophysicists for decades) is shown attached to the adjustable mounting block 315 to form the manifold assembly 350 for detection of seismic signals received through strata and rod 310, or rod 110b. The transducer 355 may be attached or removed via an attachment mechanism 318 such as a threaded connection to the adjustable mounting block.

In the aspects of FIGS. 3A and 3B, the adjustable mounting block 315 may be adjusted along the rod 310 (or along rods 110a, 110b) to aid in tuning the frequency of the transmitted or received seismic signals. Motion (e.g., multi-dimensional motion) of the rod 310 (or rods 110a, 110b) may be caused by the impact device 305 for producing signals. Alternatively, the motion may be caused by received seismic waves or signals present in the strata, the signals being detectable by the transducer 355 where electrical signals may be generated representing the detected signal. Additionally, optional fixed and/or adjustable mass 313 may be attached as a part of the manifold to further assist in tuning the manifold assembly. The optional mass 313 may be slideably attached and/or held by mechanical fasteners or the like.

FIGS. 3C and 3D are exemplary sectional views of portions of the adjustable mounting block of FIGS. 3A and 3B, the portions designated 316 and 317, respectively. FIG. 3E is an illustrative end-view of the portions of FIGS. 3C and 3D. The adjustable mounting block portions 316 and 317 are configured to mate to form the adjustable mounting block 315. The portions 316 and 317 may have securing mechanisms 319 for receiving a retainer, such as a bolt and nut or the like, to clamp the combined portions 316 and 317 onto a rod 310, 110a, 110b, to secure the resulting manifold 315. Moreover, the securing mechanisms and retainer when loosened may permit sliding of the adjustable mounting block along the rods 310, 110a, 110b to improve coupling and to provide selective rod resonance, for a particular mine strata. Holes 321 may be threaded to permit attachment and/or removal of receiving and transmitting transducers. Other types of attachments are also contemplated.

Seismic signals, as the term is used herein, may comprise any non-electromagnetic signals transferred through one or more layers of primarily solid material, including signals formed by generating and potentially modulating or otherwise controlling the characteristics of shear waves, pressure waves, multipath, ringing, or the like.

In some aspects, a specific calibrated mass that is kinetically imparted to an interfering surface stop (a manifold) may be configured to produce a seismic signal including a pressure-wave. The applied force responsible for creating the transmit pressure wave has numerous characteristics that may be maximized to create transmit waveforms with sufficient SNR for detection at a distant range. The dwell time that the “impacter” remains in contact with the manifold's stop plate, the area of intersection between the “force piston” and the stop plate, the elapsed time between subsequent impacts may be important variables that govern practical transmit efficiency and range. These parameters also may be responsible for imparting a signature to the coupled wave. For example: a specific set point of these parameters may, at the detector, possess a skewed leading edge followed by a unique exponential decay that is oscillatory and/or ringing. Knowledge of the signature and therefore, what to look for on the receiving end, may be utilized as a discriminator in processing the data in the presence of acoustic low frequency interference. Coupling of the manifold parts to the “impacter” and likewise to the strata form an impedance matching or tuning system that mechanically cooperate to produce efficient transmission/reception and hence communication.

Impacts imparted to such a cooperatively configured tuned mechanical -electrical system may be used to create “symbols.” From one up to several “symbols” may be intelligently linked to form signal “elements.” Reliably assembled “elements” may include the molecules or fundamental contents of the modulation, and hence communication.

For example, Morse code is comprised of “elements;” dots, dashes (3 times the dwell time of a dot) and spaces. The space lengths between elements within a generated character are different from those between letters and still different from the spaces between encoded words. If all spaces were equivalent in duration the message would still be exactly the same. However manual separation of letters and words may be required.

A preferred modulation scheme may be implemented for the maximum data throughput based on the minimum number of “elements” required. There may be combinations of “symbols” that are seismically imparted in the form of an applied pressure to the novel mechanically tuned system.

Each of these “symbol” types may have unique waveforms due to the above mentioned impact dwell times, pulse repetition rate or frequency (time between adjacent symbols) and applied force vs. dwell time. The greater the number of unique “symbol” types that are detectable at range, the less the number of “elements” required, resulting in fewer unique characters constructed from the elements. The symbols developed each have “waveforms” that may be unique. To further improve data throughput, “impact sequences” may be developed from the small family of successful symbol types available. Recall that each of the developed symbols, after time integration at the detector, represents a symbol-element frequency. Frequency is defined as the period in which to complete a cycle. Each “symbol-element” within the modulation scheme can have a different frequency.

At the higher level of understanding, a transmitted “message's” effective throughput rate can be increased using “tokenized sequences” where pre-defined signal patterns are assigned particular meaning. As in high speed Morse code transmissions, tokenized sequences are a short-hand use of the available alphabet. As an example, in Morse code one might have “es” represent “AND”. The “es” may include four elements that are made exclusively from the dot element. Creation of “AND” requires seven elements, namely four dots and three dashes. The quantity of symbol spaces in this example further advantage the “es” transmission. Additional examples within Morse code tokenization include: “de”=“from” and “cul” =“see you later”. Similar abbreviations may be used within this mine communication system in support of greater effective message throughput.

Preferred seismic communication systems may include a seismic alphabet that supports plain text transmission-reception capability at a practical range. Moreover, coined-tokenized apriori agreements within a “seismic language” may support superior message throughput. As an example, such a language might, for a mine communication system, beneficially include an alphanumeric “short word” composed of the minimum number of elements (and perhaps minimum number of symbols) that means “where are you?” In Morse code we send/receive “QTH?”=“what is your location: city and state.” Seismically tokenized: perhaps “EE”=“QTH?” The response may likewise be a short-handed response. A trapped miner may send the closest mine “zip code” labeled on the mine tunnel wall (perhaps uniquely labeled at 50 foot intervals). The location labels may be inherently tokenized to keep their symbol contents to a minimum. The need to determine the “QTH” of the miner that is at a transmitter node, which is co-located with a safety shelter spaced on 900 foot centers (per the Mining Act of 2006) may not even be required. This is because the originating seismic transmitter may contain its message protocol with its “tokenized” location contained in its message header. Note that the tokenization of a message may be transparent to the miner. Moreover, it is contemplated that utilizing seismic signals over a variable frequency range could be optimized to encode bidirectional messages between trapped miners and safety rescue crews.

Spread Spectrum (SS) technology is applicable in Radio Frequency (RF) systems. SS permits multiple users to occupy the same spectrum or frequency bandwidth simultaneously. Multiple users within this same spectral bandwidth may also be provided a degree of encryption. SS techniques experience improved SNR and are typically divided into two general categories; “Code Division-Multiple Access” (CDMA) and “Frequency Hopping” (FH).

Frequency Hopping SS is applicable to the seismic scheme. If the given frequency bandwidth is sub-divided into a finite number of frequency channels, multiple unique communications can successfully occur simultaneously. If each transmitting and companion receiving station utilized a FH algorithm that is unique from all other communication pair algorithms, successful operation may be achieved. When there are 16 unique RF communications existing simultaneously within the same frequency bandwidth, each “hopping” uniquely amongst 75 defined frequency channels in a precisely timed manner, communication may be achieved with excellent fidelity and without objectionable inter-channel interference.

It is true that within the SS-FH scheme there exists a probability of two communications occurring on the same channel at the same time. Distortion and interference may be minimized by each communication pair by having a random leading edge timing that most likely is offset from any other communication pair. Furthermore, the “dwell time” that each communication pair spends on a particular colliding channel may be arranged to be a small subset of time occupied by a portion of a single syllable. When the mathematics governing the number of channels, the randomness of synchronization between communication pairs coupled with the dwell time of channel access are optimized—excellent multi-channel communication within the same frequency bandwidth is achieved.

“Multipath” distortion may result when the intended incident communication is mixed with multiple-strong time delayed “echoes.” This can result in unsuccessful communication. It is expected and observed that specific seismic transmission path loss and multipath characteristics are frequency dependent. If a given “symbol” as part of an “element” includes a low frequency acoustic wave of frequency Fl, Fl can be transmitted as perhaps a “bit” within the text that is intended to be communicated. The strata may actually reflect the pressure wave along multiple paths of varying lengths beginning at the leading edge of the intended incident bit transmission. If subsequent bits in the intelligent data stream are sent at F1 also, a smearing of the seismic received data is likely to occur due to multipath. During the assigned n'th transmission bit interval unexpected time delayed n-1, n-2, . . . bits are still arriving simultaneously, thereby making it nearly impossible to recover the correct n'th bit. If however, when bit #1 at Fl has been transmitted via the optimized manifold seismic coupling system, bit #2 in the text sequence can be seismically transmitted at F2. The detection system, through the use of digital signal processing, can listen in a FH manner whereby the leading edge of bit #2 @ F2 is not smeared by the remaining incoming multipath arrivals of Fl. Fl through Fn are expected to be low frequency acoustic signals in the range from 8-1000 Hz. Due to their unique characteristics at the receiver location, they may be detected and converted back to information more easily.

For a particular embodiment of the system, the quantity of channels selected for use within this bandwidth may be determined empirically. The transmitted symbol signals may be “impact pressure waves” or may be “sinusoidal waves—or tonals” generated within this frequency range. The algorithms for changing channels in a multipath resistant manner may be self synchronizing after receipt of the first acoustic symbols. This initial asynchronous start up bit transmission sequence may be slow due to long intended/acceptable time delays between adjacent bit transmissions. This may allow mitigation of any multipath signal smearing during the synchronization process. Once synchronized, the Fl-Fn frequency hopping may ensue which may minimize the symbol bit delay times due to multipath, resulting in greater achievable data rates.

This approach to practical bidirectional-simplex transmission and reception with maximized data throughput may permit trapped miners to swiftly and efficiently communicate with rescue personnel following an event. In some instances, manual generation of seismic signals using an impact hammer, a sledge hammer, a crib block or a similar device might be used to generate the seismic impulse signals. Manual generation is generally less preferred than using automatic techniques.

In some embodiments, the system and method of the invention supports the use of manually supplied energy input to the automated system in the event that Intrinsically Safe (IS) power input has been destroyed or rendered inoperable by the event. An example could be a pneumatically operated foot pedal where storage of potential energy is loaded manually into the seismic device's internal reservoir. The storage capacity lasts long enough, when enabled, for at least one complete transmission message cycle.

In some embodiments a Repetitive Kinetic Exciter (RKE) may be capable of delivering a powerful repetitive impact sequence to a roof bolt or other seismic manifold to increase the probability of detection by the receiving transducer at greater distances. Utilizing an RKE that may provide an impact of at least 8 foot-pounds, and at a frequency in the range of 30 to 1000 Hertz, might be advantageously used as described herein.

In general, magnetostrictive transducers typically may include a large number of nickel (or other magnetostrictive material) plates or laminations arranged in parallel with one edge of each laminate attached to the bottom of a process tank or other surface to be vibrated. A coil of wire may be placed around the magnetostrictive material. When a flow of electrical current is supplied through the coil of wire, a magnetic field is created (just like high power lines). This magnetic field causes the magnetostrictive material to contract or elongate, thereby introducing compression and rarefaction wave activity that could be intelligently modulated as a seismic signal and efficiently coupled to a seismic manifold for transmission of the encoded data.

In one embodiment, it is contemplated that the use of magnetostrictive TERFENOL-D (Terbium Iron Naval Ordnance Laboratory-Dysprosium) transmitting transducers (and their well known variants) and existing receiving geophone transducers (and their variants) may be particularly advantageous. Further, it may be advantageous to utilize cluster operation (mechanical parallel operation) of multiple Terfenol-D transducers configured like a rapid fire “Gatling gun” with an interest in statically or intelligently dynamically varying the electrical phase of the excitation: all being in the sinusoidal (normal) mode or the singularity step function (impact) mode.

In some implementations, existing structures such as roof bolts may be used as seismic manifolds. However, it is contemplated that in some instances specially designed manifolds may be advantageously used to provide improved performance (both range and coupled-SNR signal strength) over existing structures.

In at least one implementation, an ability to communicate horizontally with other transceiver units, positioned to relay signals, may increase transmission range. As an example, a transceiver or equivalent apparatus may be placed in each safe station of a mine to relay signals from safe station to safe station, utilizing a networking relay technique following an event. The advantage of this approach is that the strata between refuge chambers are likely to be more contiguous horizontally and therefore have lower path loss. This configuration results may have excellent SNR and provide important improvements in system reliability. System reliability, as used herein, is the probability that, when operating under stated environmental conditions, the system will perform its intended function adequately for a specified interval of time.

Assuming that multiple seismic simplex transmissions are co-located on 900 foot centers adjacent to the required safety shelters/reserve air supply caches and that these will most likely only be in the working area of the mine, and after an event, an injured miner may not be able to walk or crawl to the nearest shelter/seismic transceiver location. A communication system configured according to principles of the invention may also include a miniature low power VHF/UHF RF link on each miner that permits remote use of the seismic transceivers. The miners' belt-held battery pack has a slight void on its underside where this module could be located. The umbilical between the battery and the helmet lamp may serve as an on-body antenna that is very close to resonance at the frequency of operation. The low-power device may battery-share on the miner battery pack. This remote accessory may permit bi-directional communication via an on-miner texting keyboard/display.

Moreover, greater seismic sensitivity at the receiver may be achieved with mechanical filtering tuned for objectionable mine environment interference by using a variant of the classical geophone. This variant may utilize high temperature compensated electrical circuits and include a low-noise capacitance multiplier. Compressions and rarefactions resulting from the transmitted “P-wave” may cause the internal distance between plate elements to vary ever so slightly, resulting in capacitance variation. Recall, C(Farads)=kAN/t, which shows the inverse relationship between C (the capacitive value) and t, the distance between the geophone's internal plate elements. Since f=½π SQRT LC, a resulting “delta frequency” will result upon receipt of the seismic message. The static “f” behaves as an acoustic Intermediate Frequency (IF), the changes in “f” may be envelope captured, peak detected and time integrated, resulting in detected recovery of the transmitted signal with improved range performance.

### Testing and Experimentation

Several tests of the system and methods were performed. Actual test results of certain aspects of the system and methods described herein were performed and results captured. The spacing of transmitters and receivers were placed at maximum available test distances of 1508 ft in the interest of supporting scalability to greater distances. The signals were recorded using a three axis geophone mounted on a steel pipe manifold cemented into a limestone wall. Three types of excitation were used at the transmit end of the communications path: a 20 pound sledge hammer, corner block, and a hammer drill.

Table 1 summarizes the results. Approximately 250 individual tests were performed; the best performance case presented for each excitation type is shown in the “Source” column. The corresponding raw SNRs at 1508 ft are shown in the adjacent column. The third column presents comparable maximum range with reduced, yet practical, SNR budget.

TABLE 1

| | | Adjusted Range |
|---|---|---|
| Source | SNR @ 1508 Feet (dB) | for 9 dB SNR (Feet) |
| Sledgehammer | 35.9 | 2831 |
| Corner Block | 28.0 | 2482 |
| Hammer Drill | 21.9 | 2212 |
| Terfenol-D Transducer | N/A | N/A |
| (Sinusoidal) | | |

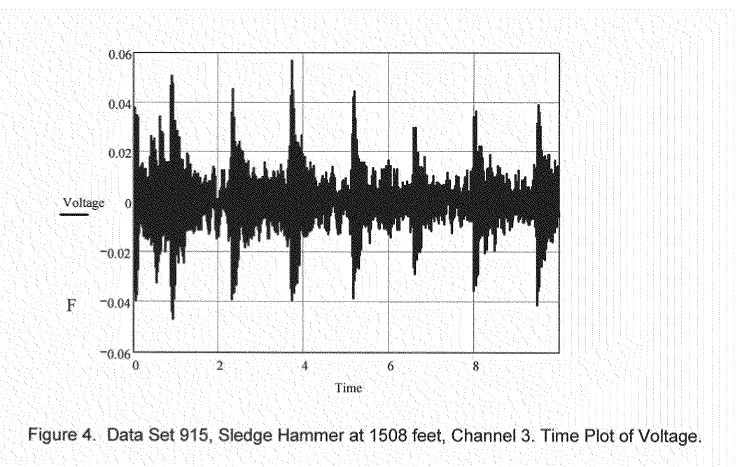

FIG. 4 is a graph of actual test results employing a 20 lb. sledge, generated according to principles of the invention (corresponding to the Sledgehammer entry of Table 1). The test was performed at a maximum distance of 1508 feet between the C and D drifts, taken with a geophone mounted in an optimum position (on top of a solid rod oriented vertically in the strata) the strongest signal was observed in channel 3 which is the “up/down” axis of the geophone. The time response (x-axis) is shown in FIG. 4 with voltage level in the y-axis. An estimate of SNR for the hit at 3.8 seconds is (0.055/0.01)²=30 (14.8 dB). This is without any filtering to suppress interference outside the frequency bands containing the major portion of the signal energy. The results reflect dataset known as Data Set 915.

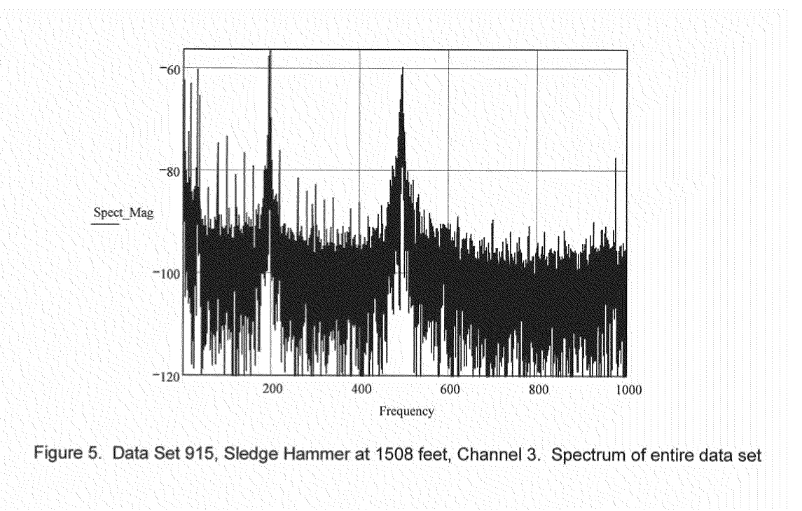

FIG. 5 is a graph of the entire 10 second spectrum of FIG. 5.

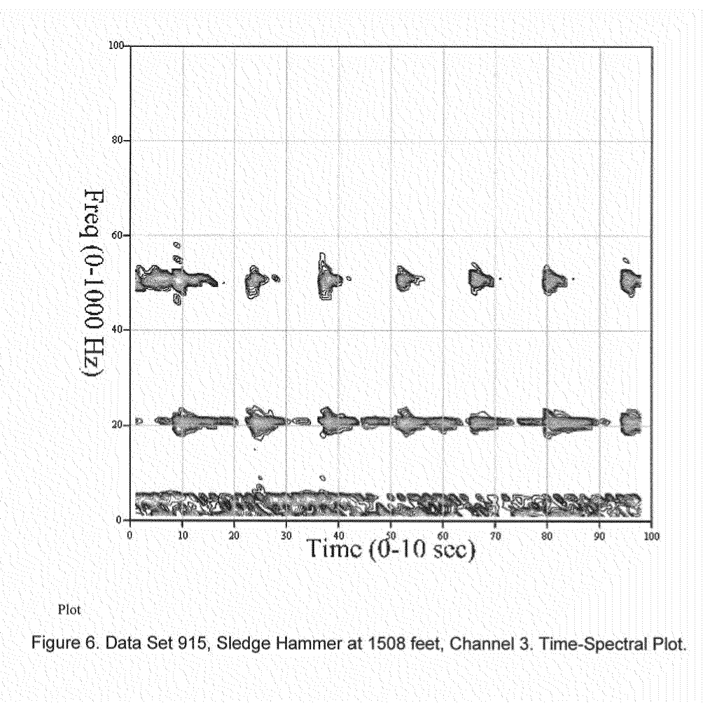

FIG. 6 is a time dependent spectral plot of the data employed in FIG. 4. The two hundred samples were processed using Fast Fourier Transform (FFT) techniques yielding nearly 100 spectral plots over the 10 second data record. Two dominate spectral regions are evident around 200 and 500 Hz. At 200 Hz the peak spectral values vary between −50 and −43 dB. At 500 Hz they range between −53 and −40 dB. In the plot, the plot floor is set at −60 dB so that the use of simple band pass filters around each frequency may provide SNR values exceeding 20 dB.

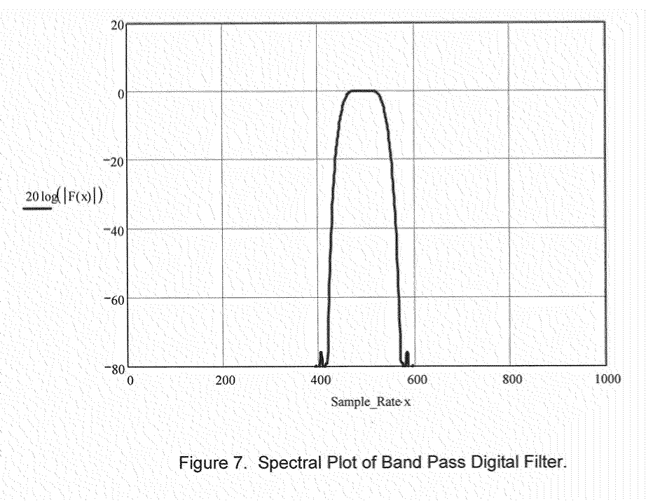

FIG. 7 is a spectral plot of a band pass digital filter. This example illustrates results of a digital filter with 181 taps. The frequency response is shown.

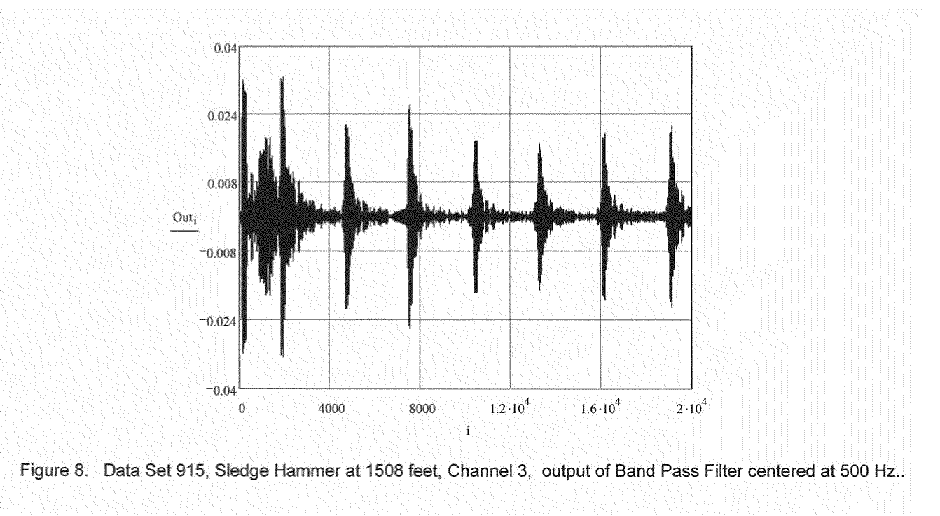

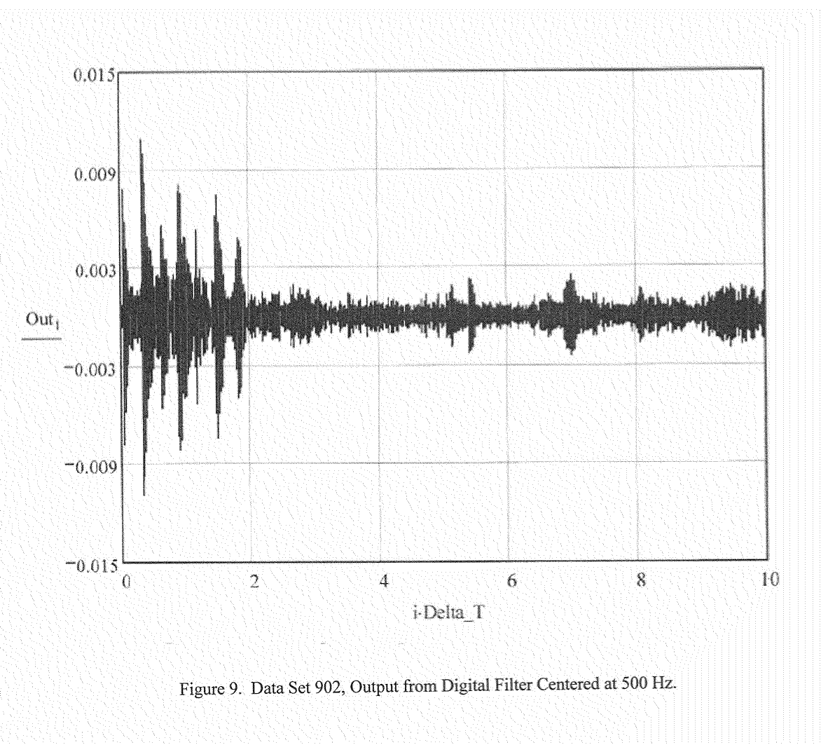

FIG. 8 is a graph of the output from the digital filter on the data of FIG. 4. The graph shows that ringing from each hit may last at least until the next hit so that the noise level cannot be determined from Data Set 915, instead another Data Set 902 is used and is shown in relation to FIG. 9.

FIG. 9 is a graph of Data Set 902 with digital filtering. Discounting the higher levels as being from mine activity that will not be present during an event, the noise level is estimated to be 0.0004 vrms. For the peak signal on FIG. 8 at 7500 samples which corresponds to 3.8 seconds, the SNR is then (0.025/0.0004)²=35.9 dB.

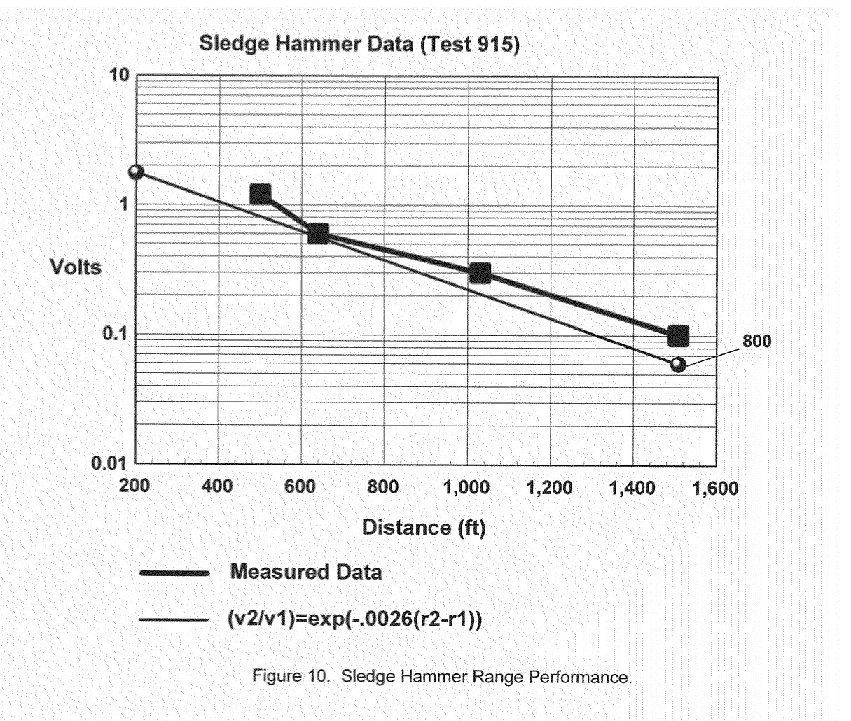

FIG. 10 is a graph of four sets of sledge hammer data plotted to determine the loss of signal as a function of range, according to principles of the invention. Sledge data from Data Set 915 is plotted to determine the loss in signal as a function of range. The line 800 of FIG. 10 is a plot of the equation (v2/v1)=exp(−0.0026(r2−r1)). The plot is a rough fit to the data from Data Set 915. The constant 0.0026 in the exponent means that each additional 885 feet in range reduces signal voltage by a factor of about 10 (20 dB).

The experimental data reveals many unique, non-harmonically related enhanced response frequencies, which may permit frequency hopping spread spectrum techniques to be implemented to improve communication throughput. Moreover, by employing frequency spread spectrum techniques; and/or acoustic frequency hopping, ringing interference and background noise may be further minimized. These techniques may permit reception of signal more accurately at the receiver side.

The transducer/rod/manifold arrangements described herein provide improved sensitivity in frequency ranges 270 Hz, 560 Hz, among others, and is not necessarily intended to be harmonically related in a normal treatment of frequency system analysis. Experimentation also revealed significant improvement in spectral sensitivity at 195 Hz and 590 Hz. This performance may permit typical Frequency Shift Keying (FSK)-narrow band excitation techniques to be utilized which typically have significant transmission benefits. By selecting a “best group” of unique frequencies, many variants of FSK may be implemented into a useful communication alphabet.

For example, the letter “A” may be represented by two transmissions of frequency one (f1) with bounded dwell times. The letter “B” may be defined with two elements: one at f1 and the second at f3—each with a prearranged dwell time. The most commonly utilized alphabet symbols may be assigned spectral resonant frequencies that perform with the maximum resonant advantages. This technique may provide maximum data throughput with minimum element-character length. Furthermore, oscillations that may occur following the transmission of an element should not deteriorate the data throughput rate since any multipath or element-character smearing will not occur at the harmonically related character's frequency assignment. Very low SNR signals can be successfully detected when time integration is performed on the received signal. This may result in lower but more reliable data rates.

The principles of the invention described herein generally include providing communications so that a trapped miner(s) can send pre-arranged communications such as tokenized messages that would communicate a predefined “location” or “position” within a mine (i.e., a type of mine “zip code”). The improved sensitivity of the system provides minimum setup time, much lower power consumption and portability that permits single man transportation of parallel operating nodes on the surface terrain.

The system and methods described herein include flexibility to be used with existing mine structures (“pseudo rods”) such as existing drill casings or roof bolts, for example. The transducers may be attached as needed to such “pseudo rods.”

Moreover, the invention is not limited to mines, but could be utilized in undersea operations, surface pipelines, or similar situations. Such use may include sensing mechanical vibrations that may be intelligently encoded. The data communicated might include information to control equipment in pipelines systems, for example. The acoustic signature of a specific version of an implementation could assist technologists and operators of pipelines with real-time confirmation of flow activity and rate, temperature of flow, or similar data—perhaps to ensure safe operations. The system and methods described herein may be used in conjunction with mining operations and may be used along with normal mining operations to obtain mineral deposits from a mine.

The foregoing description of one or more embodiments has been presented for purposes of illustration and description, and is not intended to be exhaustive or to limit the invention to the precise form or methods disclosed. Rather, it is intended that the scope of the invention not be limited by the specification, but be defined by the claims set forth below.

We claim:

1. A system for communication in mines, comprising:
a transmitting transducer coupled to a first rod at a first location; and
a receiving transducer coupled to a second rod at a second location;
wherein the transmitting transducer is configured to produce seismic waves through mine strata from the first location to the second location, the first rod embedded in the mine strata at the first location, and wherein the seismic waves are modulated to convey a message to the receiving transducer at the rod embedded in the mine strata at the second location.

2. The system of claim 1, wherein the transmitting transducer comprises an impact device to produce the seismic waves.

3. The system of claim 2, wherein the impact device comprises a magnetostrictive material.

4. The system of claim 2, wherein the impact device comprises a Terfenol-D device.

5. The system of claim 1, further comprising a manifold configured to couple the transmitting transducer to the first rod, or configured to couple the receiving transducer to the second rod.

6. The system of claim 5, wherein an adjustable mounting block component of the manifold is configured to slideably move along at least one of the first and second rods to permit selective rod resonance.

7. The system of claim 1, wherein at least one of the first rod and second rod is coupled to a mine wall.

8. The system of claim 1, wherein at least one of the first rod and second rod is embedded in a mine roof.

9. The system of claim 1, wherein the second location is proximate an uppermost surface of the strata.

10. The system of claim 1, wherein the seismic waves are transmitted employing frequency hopping spread spectrum techniques.

11. The system of claim 1, further comprising a control device configured to be connected to at least one of the transmitting transducer and the receiving transducer to select an operational parameter including at least a location identifier representative of a location of at least one of the transmitting transducer and the receiving transducer.

12. The system of claim 11, wherein the operational parameter includes a transmission modulation type.

13. The system of claim 1, wherein the receiving transducer comprises a geophone.

14. A method of communication, comprising:
providing at least one transmitting transducer configured to transmit seismic waves representing at least a portion of a message; and
providing at least one receiving transducer configured to receive the seismic wave and the at least a portion of a message,
wherein the transmitting and receiving transducers are each coupled to a rod implanted in strata.

15. The method of claim 14, further comprising transmitting the seismic waves.

16. The method of claim 14, wherein the transmitting transducer is configured to transmit the seismic waves utilizing a frequency hopping spread spectrum technique.

17. The method of claim 14, further including providing a manifold to couple one of: the at least one transmitting transducer and the at least one receiving transducers to the rod.

18. The method of claim 17, further including adjusting the location of the manifold in relation to the rod to adjust the resonance of the rod.

19. The method of claim 14, further comprising filtering the seismic wave received at the receiving transducer to improve detection of the received at least portion of the message.

20. A method of mining comprising:
providing at least one transmitting transducer configured to transmit seismic waves representing at least a portion of a message;
providing at least one receiving transducer configured to receive the seismic wave and the at least a portion of a message; and
obtaining mineral deposits from the mine,
wherein the transmitting and receiving transducers are each coupled to a rod implanted in strata.
